(19) United States
(12) Patent Application Publication
(10) Pub. No.: US 2018/0350505 A1
(43) Pub. Date: Dec. 6, 2018

(54) COIL COMPONENT AND METHOD OF MANUFACTURING THE SAME

(71) Applicant: SAMSUNG ELECTRO-MECHANICS CO., LTD., Suwon-si (KR)

(72) Inventors: Joung Gul RYU, Suwon-si (KR); Byeong Cheol MOON, Suwon-si (KR); Boum Seock KIM, Suwon-si (KR); Kang Wook BONG, Suwon-si (KR); Jin Hyuk JANG, Suwon-si (KR)

(21) Appl. No.: 15/818,490

(22) Filed: Nov. 20, 2017

(30) Foreign Application Priority Data
Jun. 5, 2017 (KR) 10-2017-0069757

(51) Int. Cl. H01F 27/28; H01F 27/32; H01F 41/04

(52) U.S. Cl. CPC H01F 27/2804; H01F 2027/2809; H01F 41/042; H01F 27/323

(57) ABSTRACT

A coil component and a method of manufacturing the same are disclosed. The coil component includes: a support member, and a coil pattern disposed on at least one surface of the support member. The coil pattern includes a first coil layer and a second coil layer disposed on the first coil layer. The second coil layer includes a lower region having the same width as that of the first coil layer and an upper region having a width greater than that of the first coil layer.

### CROSS-REFERENCE TO RELATED APPLICATION(S)

This application claims benefit of priority to Korean Patent Application No. 10-2017-0069757 filed on Jun. 5, 2017 in the Korean Intellectual Property Office, the disclosure of which is incorporated herein by reference in its entirety.

### TECHNICAL FIELD

The present disclosure relates to a coil component and a method of manufacturing the same.

### BACKGROUND

In accordance with improvements in the performance of portable devices such as smartphones, tablet personal computers (PCs), and the like, display screens have been increased in size, such that faster application processors (APs) are needed. Simultaneously, power consumption has increased due to the use of dual-core processors or quad-core processors. Therefore, thin film type inductors mainly used in direct current (DC) to DC converters, noise filters, and the like, are required to have high inductance values and low DC resistance.

In addition, in accordance with the development of information technology (IT), the miniaturization and thinning of various electronic devices have been accelerated. Therefore, the miniaturization and thinning of thin film type inductors used in these electronic devices have also been continuously demanded.

In accordance with such a trend, various attempts to provide a thin film type inductor having coil patterns that are uniform and have a high aspect ratio have been continuously undertaken.

### SUMMARY

An aspect of the present disclosure provides a coil component having a high aspect ratio and a stable structure, and a method of manufacturing the same.

According to an aspect of the present disclosure, a coil component includes a support member, and a coil pattern disposed on at least one surface of the support member. The coil pattern includes a first coil layer and a second coil layer disposed on the first coil layer. The second coil layer includes a lower region having the same width as that of the first coil layer and an upper region having a width greater than that of the first coil layer.

According to another aspect of the present disclosure, a method of manufacturing a coil component includes preparing a support member, forming a metal layer on at least one surface of the support member, and forming a first resist on the metal layer. The first resist has first opening patterns having a coil shape. The method further includes forming a second resist on the first resist. The second resist has second opening patterns having a width greater than that of the first opening patterns and having a coil shape. The method further includes disposing a conductive metal in the first and second opening patterns, and forming coil patterns by removing the first and second resists and a region of the metal layer disposed below the first resist.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a coil component according to an embodiment of the present disclosure;

FIG. 2 is a schematic perspective view illustrating the coil component according to an embodiment of the present disclosure so that coil patterns of the coil component are visible;

FIG. 3 is a schematic cross-sectional view taken along line I-I′ of FIG. 1;

FIG. 4 is a schematic cross-sectional view illustrating a coil component according to another embodiment of the present disclosure;

FIGS. 5A and 5B are views illustrating several modified examples of the coil component of FIG. 4;

FIGS. 6A through 6H are views illustrating the coil component at various stages of manufacturing the coil component of FIG. 1, using a method of manufacturing a coil component in accordance with an embodiment of the present disclosure; and

FIGS. 7A through 7I are views illustrating the coil component at various stages of manufacturing the coil component of FIG. 1, using a method of manufacturing a coil component in accordance with another embodiment of the present disclosure.

### DETAILED DESCRIPTION

Hereinafter, embodiments of the present disclosure will be described with reference to the accompanying drawings. In the accompanying drawings, shapes, sizes and the like, of the components may be exaggerated or shortened for clarity.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element, or other elements intervening therebetween may be present. In contrast, when an element is referred to as being “directly on,” “directly connected to,” or “directly coupled to” another element, there may be no other elements or layers intervening therebetween. Like numerals refer to like elements throughout. As used herein, the term “and/or” includes any and all combinations of one or more of the associated, listed items.

It will be apparent that, although the terms ‘first,’ ‘second,’ ‘third,’ etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” or the like, may be used herein for ease of description to describe one element's relationship relative to another element(s), as shown in the figures. It will be understood that spatially relative terms are intended to encompass different orientations of the device in use or operation, in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations, depending on a particular directional orientation of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape resulting from manufacturing. The following embodiments may also be constituted alone or as a combination of several or all thereof.

The contents of the present disclosure described below may have a variety of configurations, and only a required configuration is proposed herein, but the present disclosure is not limited thereto.

Hereinafter, a coil component according to an embodiment of the present disclosure will be described, and a power inductor will be described as an example of the coil component for convenience. However, the present disclosure is not limited thereto, but may also be applied to other coil components for various purposes. Example of other coil components for various purposes include a high frequency inductor, a common mode filter, a general bead, a high frequency (GHz) bead, and the like.

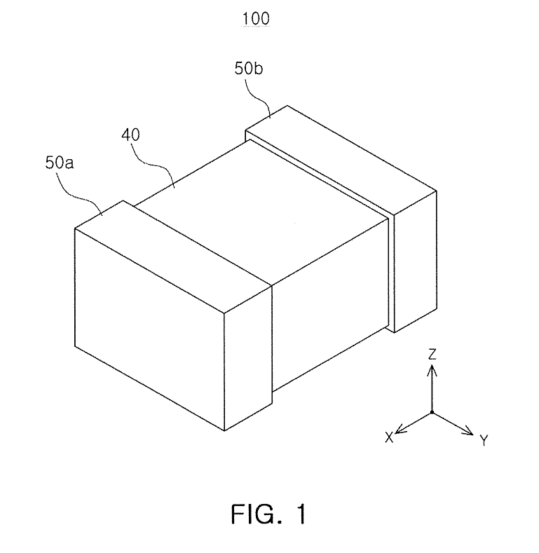

FIG. 1 is a schematic perspective view illustrating a coil component according to an embodiment of the present disclosure.

In the following description provided with reference to FIG. 1, a ‘length’ direction refers to an ‘X’ direction of FIG. 1, a ‘width’ direction refers to a ‘Y’ direction of FIG. 1, and a ‘thickness’ direction refers to a ‘Z’ direction of FIG. 1.

Referring to FIG. 1, a coil component 100 according to an embodiment of the present disclosure includes a body 40 constituting an exterior of the coil component and external electrodes 50a and 50b disposed on external surfaces of the body. The term “external electrodes” as used herein is a convenient reference for a first external electrode 50a and a second electrode 50b, unless explicitly specified otherwise or made plainly clear by context.

The body 40 forms the exterior of the coil component 100. The body 40 may have an approximately hexahedral shape having two end surfaces opposing each other in the length direction, two side surfaces opposing each other in the width direction, and upper and lower surfaces opposing each other in the thickness direction. The shape of the body, however, is not limited thereto.

The body 40 may include a magnetic material. The magnetic material may be metal powder particles including iron (Fe), chromium (Cr), or silicon (Si) as main components or may be ferrite powder particles, but is not limited thereto.

In an embodiment, the body 40 is formed by forming magnetic sheets by molding a magnetic material-resin composite including a mixture of the magnetic material and a resin in a sheet form, and stacking, compressing, and hardening the magnetic sheets on coil patterns 20 disposed on upper and lower surfaces of a support member 10, but is not limited thereto. Here, a stacking direction of the magnetic sheets may be perpendicular to a mounting surface of the coil component 100. Here, a term “perpendicular” includes a case in which an angle between two components is approximately 90°, that is, an angle between 60° to 120°, as well as a case in which the angle between the two components is exactly 90°.

The external electrodes 50a and 50b serve to electrically connect the coil component 100 to a circuit board, or the like, when the coil component 100 is mounted on the circuit board, or the like. In an embodiment, the first external electrode 50a and the second external electrode 50b are connected to a pair of lead portions of the coil patterns 20, respectively.

The external electrodes 50a and 50b may be formed of a metal having excellent electrical conductivity, for example, silver (Ag), palladium (Pd), aluminum (Al), nickel (Ni), titanium (Ti), gold (Au), copper (Cu), platinum (Pt), tin (Sn), or alloys thereof.

A method of forming the external electrode and a specific shape of the external electrode are not particularly limited. For example, the external electrodes may be formed in a C shape by a dipping method. Detailed shapes of the first and second external electrodes 50a and 50b are not limited. For example, the first and second external electrodes 50a and 50b may not extend to the upper surface of the body 40, due to having an “L” shape, and may also be provided as lower electrodes only disposed on the lower surface of the body 40, if desired. The first external electrode 50a and the second external electrode 50b need not have the same shape. For example, in an embodiment, the first external electrode 50a is C-shaped and the second external electrode 50b is L-shaped.

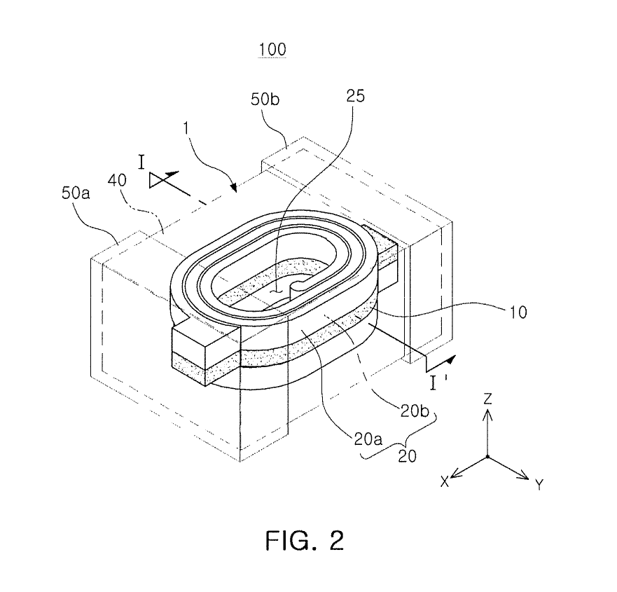

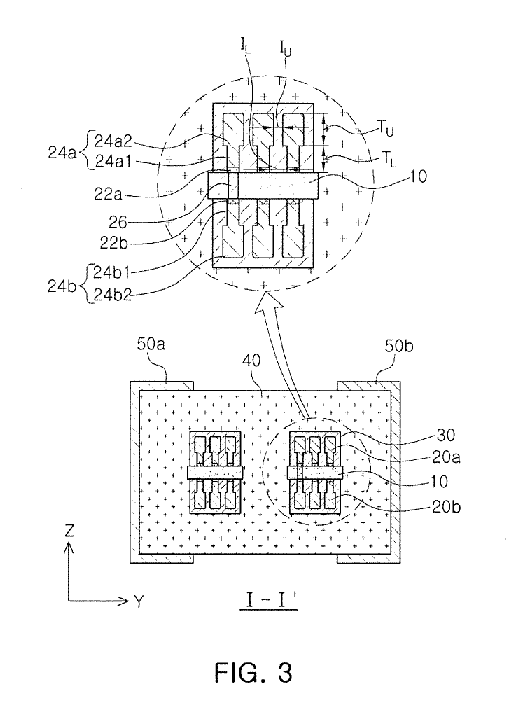

FIG. 2 is a schematic perspective view illustrating the coil component according to an embodiment of the present disclosure so that coil patterns of the coil component are visible, and FIG. 3 is a schematic cross-sectional view taken along line I-I′ of FIG. 1. An internal structure of the body of FIG. 1 will be described in more detail with reference to FIGS. 2 and 3.

The support member 10 is provided in the body 40 and serves to support the coil patterns 20.

The support member 10 may be an insulating substrate including an insulating resin. Here, the insulating resin may be a thermosetting resin such as an epoxy resin, a thermoplastic resin such as a polyimide resin, a resin having a reinforcing material such as a glass fiber or an inorganic filler impregnated in the thermosetting resin and the thermoplastic resin, such as prepreg, Ajinomoto Build up Film (ABF), FR-4, a Bismaleimide Triazine (BT) resin, a photo-imagable dielectric (PID) resin, or the like. When the glass fiber is included in the support member 10, rigidity of the support member may be improved.

In an embodiment, a through-hole is formed in a central region of the support member 10, and is filled with the same material as a material constituting the body 40 to form a core part 25. In this case, magnetic permeability of the coil component may be further improved. The core part 25 constitutes a portion of the body 40 in an embodiment.

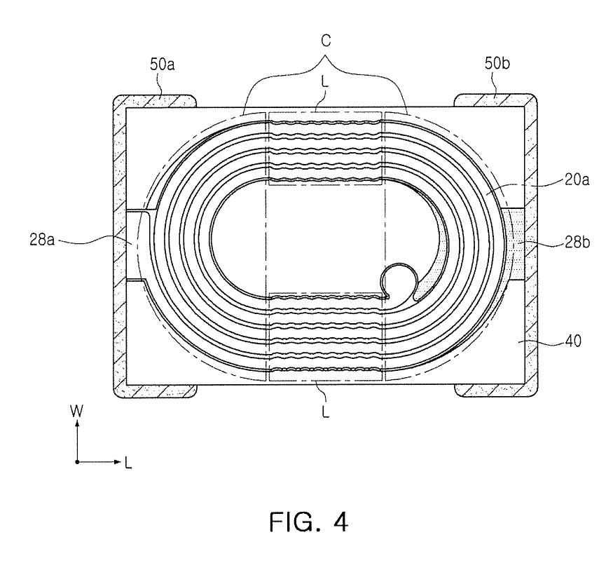

The coil patterns 20 include first and second coil patterns 20a and 20b formed on opposite surfaces of the support member 10. The first and second coil patterns 20a and 20b are formed in a spiral shape, and are electrically connected to each other through a via 26 penetrating through the support member 10. First and second lead portions 28a and 28b (see FIG. 4) exposed externally of the body 40 are provided in the outermost portions of the first and second coil patterns 20a and 20b, respectively, for the purpose of electrical connection between the first and second coil patterns 20a and 20b and the external electrodes 50a and 50b. The first and second lead portions 28a and 28b are exposed to both end surfaces of the body 40 in the length direction, respectively. In an embodiment, the first and second lead portions 28a and 28b, which constitute portions of the outermost regions of the first and second coil patterns 20a and 20b, respectively, are formed integrally with the first and second coil patterns 20a and 20b, respectively.

The coil pattern 20 may be formed of a metal having high electrical conductivity, for example, silver (Ag), palladium (Pd), aluminum (Al), nickel (Ni), titanium (Ti), gold (Au), copper (Cu), platinum (Pt), or alloys thereof. In this case, as an example of a preferable process for manufacturing a thin film shape, an electroplating method may be used. Alternatively, other processes known in the related art may also be used as long as an effect similar to an effect of the electroplating method may be accomplished.

The coil patterns 20 include first coil layers 22a and 22b and second coil layers 24a and 24b each disposed on the first coil layers 22a and 22b, respectively.

The first coil layers 22a and 22b may serve as plating seeds in relation to the corresponding second coil layers.

Generally, plating seeds have a structure in which all the external surfaces thereof are covered by plating layers formed on the plating seeds. However, the first coil layers 22a and 22b according to an embodiment have a structure in which only upper surfaces thereof are entirely covered by the second coil layers disposed thereon and at least portions of side surfaces thereof are not covered by the second coil layers disposed thereon. That is, the upper surfaces of the first coil layers 22a and 22b are in contact with lower surfaces of the second coil layers 24a and 24b, respectively, and the side surfaces of the first coil layers 22a and 22b are not covered by the second coil layers 24a and 24b, respectively. A width of the upper surfaces of the first coil layers 22a and 22b may thus be substantially the same as that of the lower surfaces of the second coil layers 24a and 24b.

Generally, a width of the plating seeds disposed to be in contact with the support member is smaller than that of the plating layers formed on the plating seeds. However, in some cases, it may be difficult to form the plating layers at a height of a predetermined level or more while making distances between the plating layers uniform. That is, there maybe a limitation in growing the plating layers in the thickness direction, and it may thus be difficult to sufficiently increase an aspect ratio of the coil patterns in some instances.

However, in the present disclosure, the widths of the upper surfaces of the first coil layers 22a and 22b are substantially the same as those of the lower surfaces of the second coil layers 24a and 24b, and an aspect ratio of the coil patterns may be stably increased while making an interval between adjacent patterns of the coil patterns smaller. For example, the aspect ratio of the coil patterns may be 2 or more to 20 or less. When the aspect ratio of the coil patterns is smaller than 2, an improvement in electrical characteristics, and the like, of the coil component may not be significant, and when the aspect ratio of the coil patterns is greater than 20, there may be a difficulty in a process such as collapse of the coil patterns, warpage of the support member, or the like, in a process of forming the coil patterns.

The second coil layers 24a and 24b include lower regions 24a1 and 24b1 having the same width of that of the first coil layers and upper regions 24a2 and 24b2 having a width greater than that of the corresponding first coil layers, respectively. That is, in some embodiments, the second coil layers 24a and 24b have a T shape when viewed in a cross section of the coil component in a thickness-width direction.

In embodiments where the second coil layers 24a and 24b include the lower regions and the upper regions as described above, an area of a lower surface of a resist for forming the coil patterns may be widely secured, and a space in which the coil patterns are filled may be sufficiently secured. Therefore, structural reliability of the coil component may be improved, thereby avoiding issues such as occurrence of a short-circuit, or the like, and securing a high aspect ratio.

When the sum of a height of each of the first coil layers 22a and 22b and a height of each of the lower regions 24a1 and 24b1 of the second coil layers is T_{L} and a height of each of the upper regions 24a2 and 24b2 of the second coil layers is T_{U}, T_{U}/T_{L} may be 2 or more. When T_{U}/T_{L} is less than 2, an improvement in the structural reliability of the coil component may be insufficient.

When an interval between adjacent coil patterns of each of the first coil layers 22a and 22b is I_{L} and an interval between adjacent coil patterns of each of the upper regions of the second coil layers 24a and 24b is I_{U}, I_{U}/I_{L} may be in a range from about 0.5 to about 1. When I_{U}/I_{L} is less than 0.5 or more than 1, the improvement in the structural reliability of the coil component may be insufficient and the space in which the coil patterns are filled may be insufficiently secured, such that coil characteristics may be deteriorated.

The first coil layers 22a and 22b and the second coil layers 24a and 24b may be formed of the same material, but may also be formed of different materials. Examples of materials for each of the first and second coil layers include, without limitation, one or more selected from the group consisting of copper (Cu), titanium (Ti), nickel (Ni), tin (Sn), molybdenum (Mo), aluminum (Al), and any alloys thereof. Particularly, the first coil layers 22a and 22b may include titanium (Ti) or nickel (Ni), and the second coil layers 24a and 24b disposed on the first coil layers 22a and 22b, respectively, may include copper (Cu), which is considered in terms of all of electrical conductivity, economic efficiency, and ease of processing.

The first coil layers 22a and 22b and the via 26 in contact with at least portions of the first coil layers 22a and 22b may be formed of different materials. Likewise, the first coil layers 22a and 22b may include titanium (Ti) or nickel (Ni), and the via 26 may include copper (Cu). In this case, boundary surfaces may exist between the first coil layers 22a and 22b and the via 26, such that the first coil layers 22a and 22b and the via 26 may be discontinuously disposed. For reference, in a structure of a general coil component, a via and a plating seed connected to the via are simultaneously formed, such that the via and the plating seed may not be distinguished from each other and the via and the plating seed are continuously configured. However, in the coil component according to an embodiment of the present disclosure, the via 26 and the first coil layers 22a and 22b disposed on the via 26 is formed by different processes, such that the via 26 and the first coil layers 22a and 22b are distinguished from each other and are discontinuously configured.

The lower regions 24a1 and 24b1 and the upper regions 24a2 and 24b2 of the second coil layers may be simultaneously formed, but may also be formed separately. Forming the upper and lower regions separately may be advantageous in reducing a plating deviation, and therefore, also advantageous in improving the structural reliability of the coil component.

An insulating material 30 is formed on surfaces of the coil patterns 20 to secure insulation properties between the coil patterns 20 and other components. The insulating material 30 is not particularly limited. For example, the insulating material 30 may include a poly (p-xylylene), an epoxy resin, a polyimide resin, a phenoxy resin, a polysulfone resin, and a polycarbonate resin, or a perylene based compound resin. For example, an insulating material including a perylene based compound may be uniformly and stably disposed using chemical vapor deposition.

The insulating material 30 may fill spaces between adjacent patterns of the coil patterns 20. That is, the insulating material disposed between the adjacent coil patterns 20 may completely fill at least the entirety of space between adjacent coil patterns from the lowermost portion of the coil patterns 20 to the uppermost portions of the coil patterns 20.

FIG. 4 is a schematic cross-sectional view illustrating a coil component according to another embodiment of the present disclosure.

Referring to FIG. 4, coil patterns 20 may include a plurality of curved regions C and a plurality of connecting regions L connecting the plurality of curved regions C to each other. Here, the connecting regions L are substantially linear.

At least some of the coil patterns 20 may have a shape in which flexions are formed on side surfaces thereof. When at least some of the coil patterns 20 have a wrinkled or undulating shape due to the flexions formed on the side surfaces thereof, a contact area between the support member 10 and the coil patterns 20 is increased. As a result, an aspect ratio of the coil patterns 20 may be increased without compromising the structural reliability that may degrade due to collapse of the coil patterns.

The coil patterns having the shape in which the flexions are formed on the side surfaces thereof as described above may constitute at least portions of the connecting regions L. The reason is that the possibility that deformation of the coil patterns will occur in the connecting regions L is relatively higher than the possibility that deformation of the coil patterns will occur in the curved region C.

Regions having the wrinkled or undulating shape in the coil patterns may be appropriately set in consideration of a chip size, an DC resistance (Rdc) value, and the like. For example, the regions having the wrinkled or undulating shape may be disposed symmetrically to each other in the connecting regions L facing each other in relation to the core part 25, but are not limited thereto.

A specific shape of the flexions formed on the side surfaces of the coil patterns 20 is not limited. That is, the coil patterns 20 may have a structure in which positive radii of curvature and negative radii of curvature are repeated due to repetition of ridges and valleys. Here, specific shapes of the ridges and the valleys are not limited. That is, the ridges and the valleys maybe formed in a curved shape or may have sharp points.

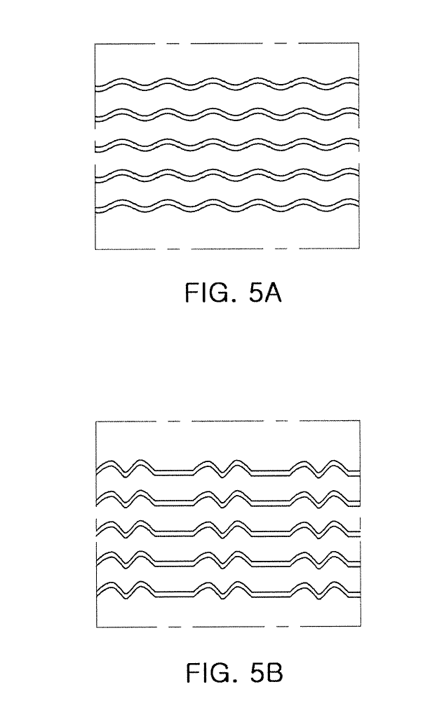

FIGS. 5A and 5B are views illustrating alternative examples of shapes of flexions of the coil component of FIG. 4. The coil patterns 20 may have a structure in which ridges and valleys having a large radius of curvature are repeated as illustrated in FIG. 5A, or may have a structure in which regions in which flexions are formed (i.e., regions that have a wrinkled shape) and regions in which the flexions are not formed (i.e., regions that are substantially straight) are alternately repeated, as illustrated in FIG. 5B.

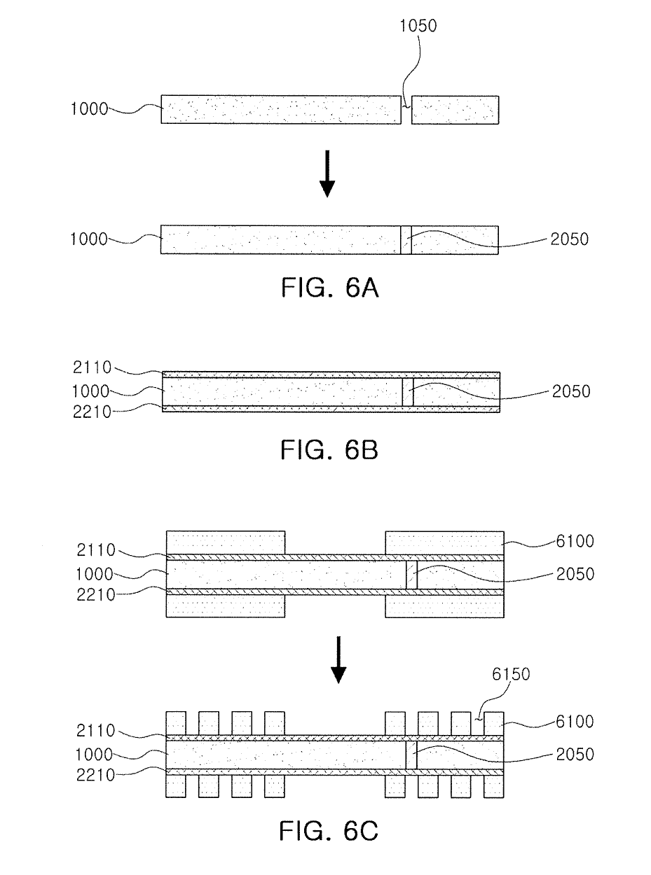

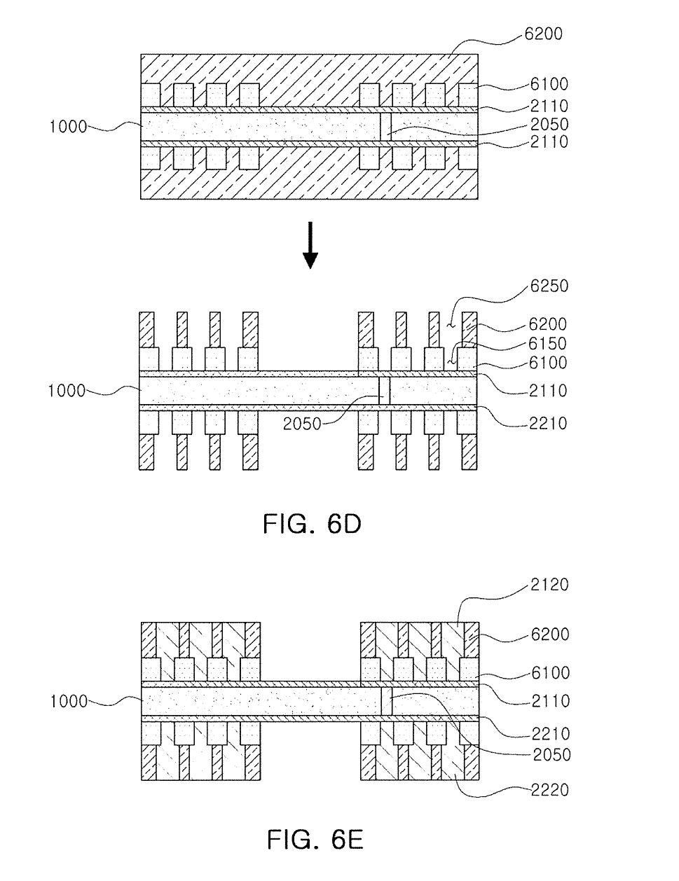

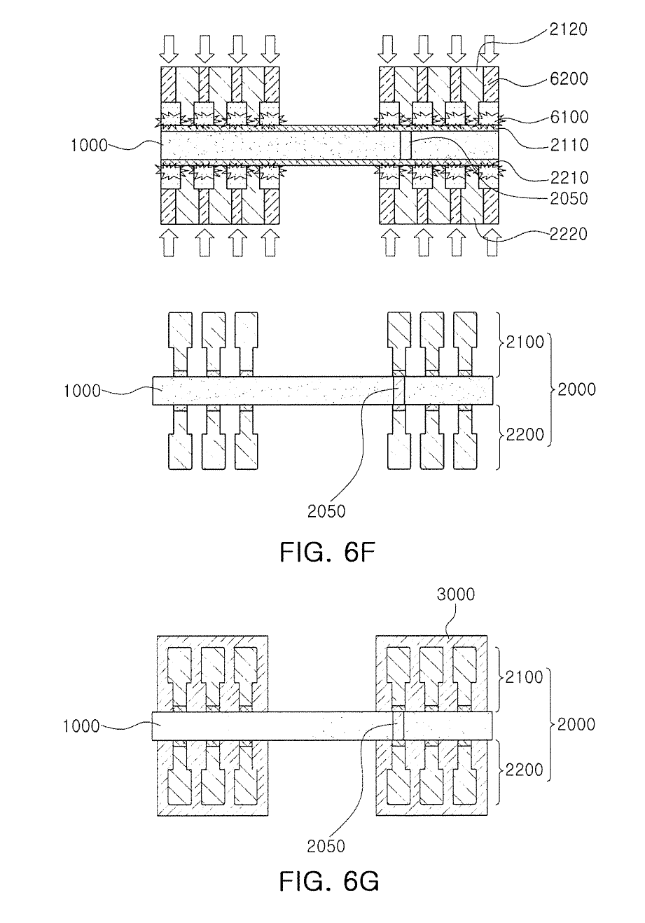

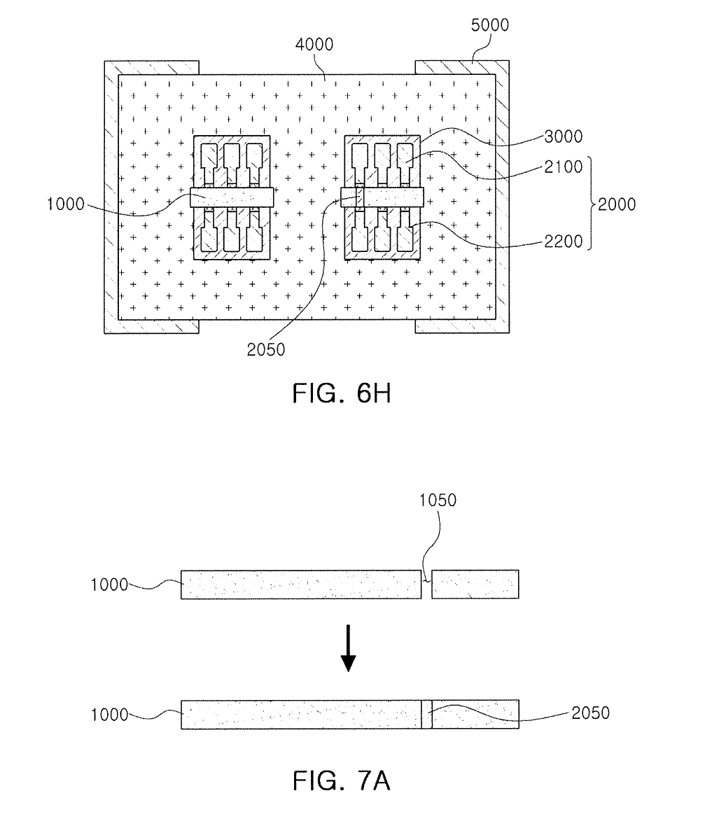

FIGS. 6A through 6H are views illustrating the coil component at various stages of manufacturing using a method manufacturing according to an embodiment of the present disclosure. Referring to FIG. 6A, a support member 1000 in which a via hole 1050 is prepared, and a conductive metal 2050 is filled in the via hole 1050. The conductive metal 2050 constitutes a via electrically connecting first and second coil patterns 2100 and 2200 to be described below to each other. The conductive metal 2050 may be copper (Cu), but is not limited thereto.

Referring to FIG. 6B, metal layers 2110 and 2210 are formed on the top and bottom surfaces of the support member 1000, respectively. The metal layers 2110 and 2210 constitute first coil layers through subsequent process. A method of forming the metal layers 2110 and 2210 is not limited, and may be a method that may form metal layers, which are uniform thin films. For example, sputtering, chemical copper plating, chemical vapor deposition (CVD), or the like, may be used. A thickness of each of the plating layers 2110 and 2210 may be appropriately configured through a design change by those skilled in the art, and may be in a range from about 50 nm to about 1 μm, but is not particularly limited thereto. A material of each of the metal layers 2110 and 2210 is not particularly limited, but is a material having electrical conductivity, and may include titanium (Ti) or nickel (Ni) as a main component in order to significantly reduce remaining metal layers when considering a process of removing portions of metal layers to be described below.

Referring to FIG. 6C, first resist 6100 having first opening patterns 6150 is formed on the metal layers 2110 and 2210. In an embodiment, the first resist 6100 is formed by the known photolithography method, but the method is not limited thereto. A material of the first resist 6100 may be any photosensitive polymer that may be stripped after the opening patterns are formed and selectively reacts to light. For example, the first resist 6100 may be a negative photoresist or a positive photoresist. Here, the negative photoresist may be a photosensitive polymer in which only a polymer of a portion (an exposed portion) in contact with light is hardened, such that only the polymer of the exposed portion remains after a development process. Examples of the negative photoresist include aromatic bisazide, methacrylic acid ester, cinnamic acid ester, or the like, but are not limited thereto. The positive photoresist maybe a photosensitive polymer in which only the polymer of a portion exposed to light is broken down, such that the non-exposed portion remains after a development process and exposed portion dissolves away. Examples of the positive photoresist include polymethyl methacrylate, naphthoquinone diazide, polybutene-1 sulfone, or the like, but are not limited thereto.

Referring to FIG. 6D, second resist 6200 having second opening patterns 6250 having a width greater than that of the first opening patterns and having a coil shape are formed on the first resists 6100. Materials that could be used as the second resist 6200 and methods of forming the second resist 6200 are the same as those of the first resist 6100. A detailed description therefor will thus be omitted.

Referring to FIG. 6E, conductive metals 2120 and 2220 are formed in the first and second opening patterns 6150 and 6250. In an embodiment, the metal layers 2110 and 2210 serve as seed layers for the conductive metals 2120 and 2220 filled in the first and second opening patterns 6150 and 6250. Alignment between the conductive metals 2120 and 2220 and the metal layers 2110 and 2210 is thus important. According to an example of methods disclosed in the present disclosure, the metal layers 2110 and 2210 are continuously disposed on an upper surface of the support member 1000. A restriction of positions in which the opening patterns 6150 and 6250 and the conductive metals 2120 and 2220 are formed is, therefore, not large. As a result, line widths of coil patterns including first and second plating layers may be easily be reduced.

In FIG. 6E, when upper surfaces of the conductive metals 2120 and 2220 filled in the first and second opening patterns 6150 and 6250 are disposed on a level above upper surfaces of the second opening patterns 6250, a polishing process may be additionally required to prevent short-circuits between adjacent conductive metals 2120 and 2220. In an embodiment, mechanical polishing or chemical polishing may be used, and those skilled in the art may appropriately undertake a design change depending on design requirements. When upper surfaces of the conductive metals 2120 and 2220 filled in the first and second opening patterns 6150 and 6250 are disposed on a level below upper surfaces of the second opening patterns 6250 to be thus underplated, the polishing process may be omitted.

Referring to FIG. 6F, the first and second resists 6100 and 6200 and regions of the metal layers 2110 and 2210 disposed below the first resist 6100 are removed to form coil patterns 2000. In an embodiment, regions of the metal layers 2110 and 2210 disposed below the conductive metals 2120 and 2220 filled in the first and second opening patterns 6150 and 6250 are not removed. The first and second resists 6100 and 6200 and the regions of the metal layers 2110 and 2210 disposed below the first resist 6100 maybe removed by, for example, laser trimming, but the techniques are not limited thereto.

Referring to FIG. 6G, an insulating material 3000 is formed on surfaces of coil patterns 2100 and 2200 to surround the entirety of the surfaces of the coil patterns 2100 and 2200. A specific method of forming the insulating material is not particularly limited, but may be, for example, a CVD or sputtering method. In addition, the insulating material is not particularly limited, but may be, for example, a perylene resin.

Referring to FIG. 6H, a body 4000 including a magnetic material encapsulating the coil patterns that are insulation-coated, and external electrodes 5000 is formed on external surfaces of the body to complete manufacture of the coil component.

A description for features overlapping those of the coil component according to the embodiment of the present disclosure described above except for the abovementioned description will be omitted.

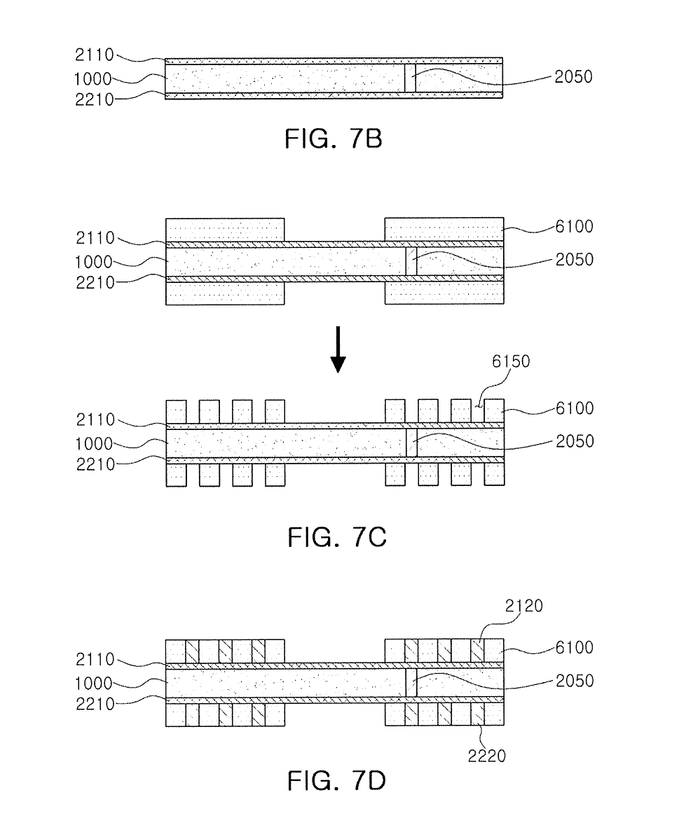

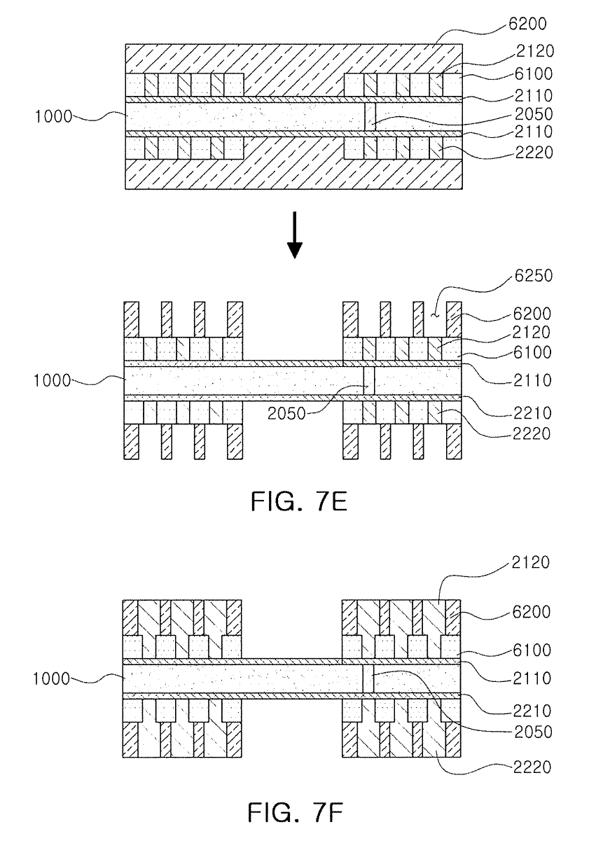

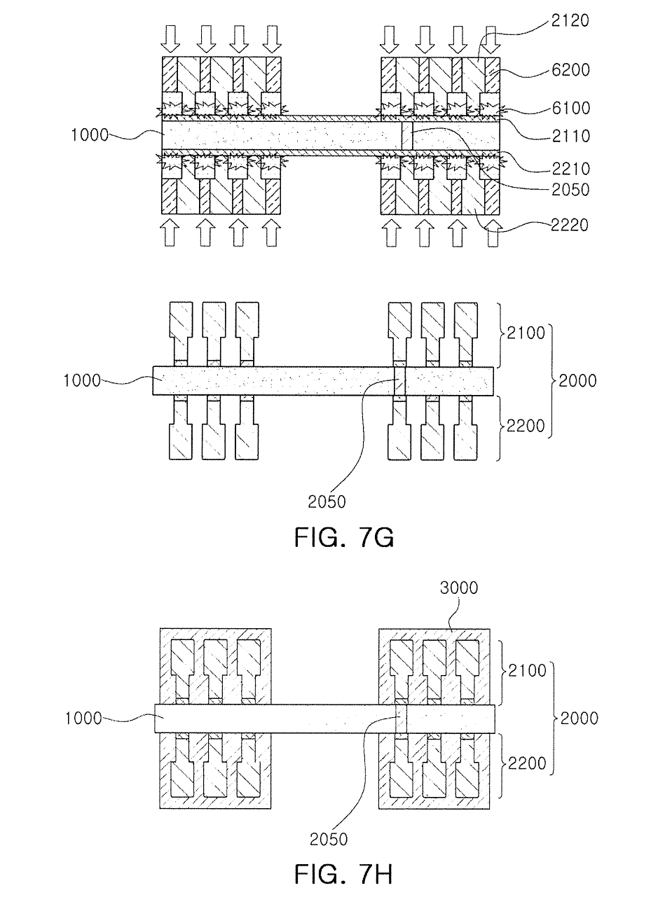

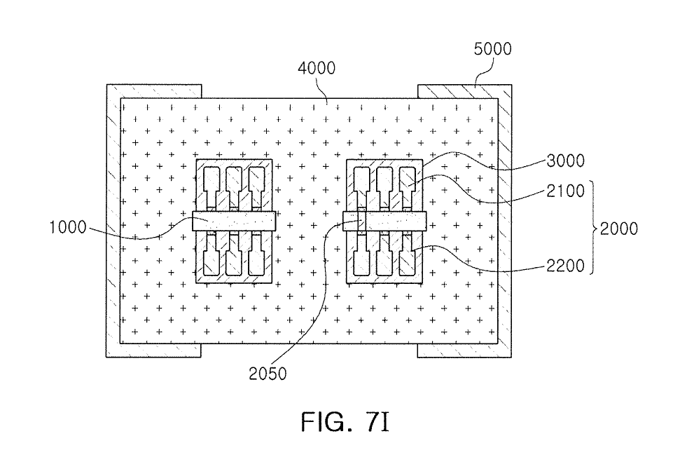

FIGS. 7A through 7I are views illustrating cross-section of the coil component at various stages of manufacturing using a method manufacturing according to another embodiment of the present disclosure.

A method of manufacturing the coil component illustrated in FIGS. 7A through 7I is substantially similar to that of the method of manufacturing the coil component FIGS. 6A through 6H except that conductive metals constituting lower regions of second coil layers and conductive metals constituting upper regions of the second coil layers are filled in opening patterns in different processes. It may be advantageous in reducing a plating deviation that the upper and lower regions of the second coil layers are formed in separate processes. Therefore, it may be more advantageous in improving the structural reliability of the coil component that the upper and lower regions are formed in the separate processes.

A description for features overlapping those of the method of manufacturing the coil component according to an embodiment of the present disclosure described above except for the abovementioned description will be omitted.

As set forth above, according to an embodiment of the present disclosure, a coil component capable of having a high aspect ratio and a stable structure may be obtained.

While embodiments have been shown and described above, it will be apparent to those skilled in the art that modifications and variations could be made without departing from the scope of the present invention as defined by the appended claims.

What is claimed is:

1. A coil component comprising:
a support member; and
a coil pattern disposed on at least one surface of the support member, wherein the coil pattern includes a first coil layer and a second coil layer disposed on the first coil layer, and the second coil layer includes a lower region having the same width as that of the first coil layer and an upper region having a width greater than that of the first coil layer.

2. The coil component of claim 1, wherein T_{U}/T_{L} is 2 or more, wherein T_{L} is a sum of a height of the first coil layer and a height of the lower region of the second coil layer and Tᵤ is a height of the upper region of the second coil layer.

3. The coil component of claim 1, wherein Iᵤ/I_{L} is 0.5 or more and is less than 1, wherein I_{L} is an interval between adjacent coil patterns of the first coil layer and I_{U} is an interval between adjacent coil patterns of the upper region of the second coil layer.

4. The coil component of claim 1, wherein the first coil layer and the second coil layer comprise different materials.

5. The coil component of claim 4, wherein the first coil layer comprises titanium (Ti) or nickel (Ni) and the second coil layer comprises copper (Cu).

6. The coil component of claim 1, wherein the lower region and the upper region of the second coil layer are disposed discontinuously to include a boundary surface between the lower region and the upper region.

7. The coil component of claim 1, wherein at least some of the coil patterns have flexions formed on side surfaces thereof.

8. The coil component of claim 7, wherein the coil patterns include a plurality of curved regions and a plurality of connecting regions connecting the plurality of curved regions to each other, and the coil patterns having the flexions formed on the side surfaces thereof constitute at least portions of the connecting regions.

9. The coil component of claim 1, wherein the coil patterns include first and second coil patterns formed on top and bottom surfaces of the support member, respectively.

10. The coil component of claim 9, wherein the first and second coil patterns are electrically connected to each other by a via penetrating through the support member.

11. The coil component of claim 1, further comprising an insulating material formed on surfaces of the coil patterns.

12. The coil component of claim 11, wherein the insulating material fills spaces between adjacent patterns of the coil patterns.

13. The coil component of claim 1, further comprising a body encapsulating the support member and the coil patterns, and including a magnetic material.

14. The coil component of claim 13, further comprising external electrodes disposed on external surfaces of the body.

15. A method of manufacturing a coil component, comprising:
preparing a support member;
forming a metal layer on at least one surface of the support member;
forming a first resist on the metal layer, the first resist having first opening patterns having a coil shape;
forming a second resist on the first resist, the second resist having second opening patterns having a width greater than that of the first opening patterns and having a coil shape;
disposing a conductive metal in the first and second opening patterns; and
forming coil patterns by removing the first and second resists and a region of the metal layer disposed below the first resist.

16. The method of claim 15, wherein disposing a conductive metal comprises disposing a first metal in a first portion of the first opening and disposing a second metal in a second portion of the first opening and in the second opening, wherein the first portion does not extend higher than a thickness of the first resist.

17. The method of claim 16, wherein the first metal is different from the second metal.
